(19) United States
(12) Patent Application Publication
(10) Pub. No.: US 2024/0088489 A1
(43) Pub. Date: Mar. 14, 2024

(54) POWER STORAGE DEVICE

(71) Applicant: TOYOTA JIDOSHA KABUSHIKI KAISHA, Toyota-shi Aichi-ken (JP)

(72) Inventor: Akira KOHYAMA, Toyoake-shi Aichi-ken (JP)

(73) Assignee: TOYOTA JIDOSHA KABUSHIKI KAISHA, Toyota-shi Aichi-ken (JP)

(21) Appl. No.: 18/221,688

(22) Filed: Jul. 13, 2023

(30) Foreign Application Priority Data
Sep. 8, 2022 (JP) 2022-143152

(51) Int. Cl. H01M 50/124; H01M 50/105; H01M 50/119; H01M 50/121; H01M 50/186

(52) U.S. Cl. CPC H01M 50/124; H01M 50/105; H01M 50/119; H01M 50/121; H01M 50/186

(57) ABSTRACT

The power storage device includes an electrode body and an exterior body made of a laminate film that houses the electrode body. The laminate film has a barrier layer which is a metal layer, and a sealing layer laminated on a surface of the barrier layer facing the electrode body. In the barrier layer, a through hole that penetrates the barrier layer in the thickness direction is formed. The diameter of the through hole is 3 mm or more and 10 mm or less. The laminate film further includes a resin portion disposed in the through hole.

### CROSS-REFERENCE TO RELATED APPLICATION

This application claims priority to Japanese Patent Application No. 2022-143152 filed on Sep. 8, 2022 incorporated herein by reference in its entirety.

### BACKGROUND

### 1. Technical Field

The present disclosure relates to a power storage device.

### 2. Description of Related Art

Japanese Unexamined Patent Application Publication No. 2017-10946 (JP 2017-10946 A) discloses a lithium secondary battery including an electrode laminate and a battery case that accommodates the electrode laminate. The battery case is made of a laminate sheet having a plurality of pores. A gas generated from the electrode laminate is discharged to the outside through the pores in the laminate sheet.

### SUMMARY

In a battery described in JP 2017-10946 A, the internal pressure may increase due to generation of the gas inside the battery case. This increase in the internal pressure is a factor related to the life of the battery. In order to alleviate the increase in the internal pressure, it is required to improve the permeability of the generated gas to the outside of the battery case.

In the present disclosure, a power storage device capable of improving the gas permeability of an exterior body made of a laminate film is proposed.

A power storage device according to the present disclosure includes: an electrode body; and an exterior body that accommodates the electrode body and that is made of a laminate film. The laminate film includes a metal layer and a resin layer laminated on a surface of the metal layer facing the electrode body. A through hole penetrating the metal layer in a thickness direction is provided in the metal layer. A diameter of the through hole is 3 mm or more and 10 mm or less. The laminate film further includes a resin portion disposed in the through hole.

When the through hole is provided in the metal layer and the diameter of the through hole is set to be equal to or larger than 3 mm and equal to or smaller than 10 mm, it is possible to improve the gas permeability of the exterior body. By the resin portion, it is possible to suppress moisture from entering the inside of the exterior body from the outside through the through hole.

In the above-described power storage device, a part of the resin layer protruding into the through hole may serve as a resin portion. Thus, the resin portion can be easily formed. Then, the through hole can be reliably sealed by the resin portion.

In the above-described power storage device, the resin portion may include a resin material of a kind different from a material used for the resin layer. As a result, an appropriate resin material satisfying a necessary function can be selected as each of the material used for the resin layer and the material used for the resin portion.

In the above-described power storage device, the resin portion may include a resin material having a lower moisture permeability than the material used for the resin layer. Accordingly, it is possible to more reliably suppress the moisture from entering the inside through the through hole.

In the above-described power storage device, an area ratio of the through hole to an area of the metal layer may be 3% or more and 40% or less. When the area ratio of the through holes is 3% or more, the permeation rate of a gas can be ensured. Then, an effect of improving the gas permeability of the exterior body can be reliably obtained. When the area ratio of the through holes is 40% or less, the mechanical strength of the laminate film can be ensured.

In the above-described power storage device, it is desirable that a hole that is macroscopically visible be not provided in the resin layer. Accordingly, it is possible to reliably suppress the liquid inside the power storage device from leaking to the outside.

According to the power storage device of the present disclosure, it is possible to improve the gas permeability of the exterior body.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a cross-sectional view illustrating a schematic configuration of a power storage device according to an embodiment;

FIG. 2 is a plan view of the power storage device as viewed from the arrow II shown in FIG. 1;

FIG. 3 is a cross-sectional view of an exterior body showing an enlarged area III shown in FIG. 1;

FIG. 4 is a cross-sectional view showing an exterior body of another embodiment; and

FIG. 5 is a table showing evaluation results of Examples and Comparative Examples.

### DETAILED DESCRIPTION OF EMBODIMENTS

Hereinafter, embodiments will be described with reference to the drawings. In the following description, the same components are denoted by the same reference numerals. The same applies to names and functions thereof. Therefore, detailed descriptions thereof will not be repeated.

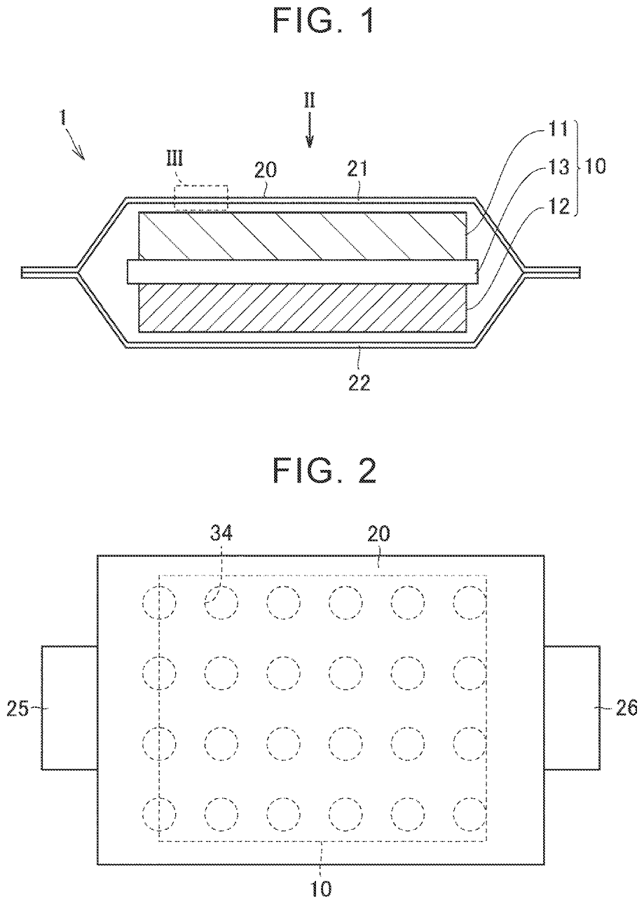

FIG. 1 is a cross-sectional view illustrating a schematic configuration of a power storage device 1 according to an embodiment. The power storage device 1 is, for example, a non-aqueous secondary battery such as a lithium-ion battery. The power storage device 1 is mounted on a vehicle and used, for example. Exemplary vehicles may include hybrid electric vehicle, plug-in hybrid electric vehicle, battery electric vehicle, and fuel cell electric vehicle. A battery pack in which a plurality of power storage devices 1 are arranged in a single assembly is mounted on a vehicle.

As illustrated in FIG. 1, the power storage device 1 includes an electrode body 10. The electrode body 10 includes a positive electrode 11, a negative electrode 12, and a separator 13. The positive electrode 11 may include a positive electrode current collector and a positive electrode active material layer. The positive electrode current collector may include an aluminum foil. The negative electrode 12 may include a negative electrode current collector and a negative electrode active material layer. The negative electrode current collector may include a copper foil. The separator 13 is disposed between the positive electrode 11 and the negative electrode 12. The separator 13 is formed of an insulating material such as resin, and electrically insulates the positive electrode 11 and the negative electrode 12 from each other. The electrode body 10 is immersed in an electrolytic solution (not shown).

FIG. 2 is a plan view of the power storage device 1 as viewed from the arrow II shown in FIG. 1. The power storage device 1 includes an exterior body 20. The exterior body 20 accommodates the electrode body 10 and the electrolytic solution therein. The exterior body 20 is formed of a laminate film. The exterior body 20 includes a first laminated film 21 and a second laminated film 22. The exterior body 20 is formed by welding the peripheral edge portion of the first laminate film 21 and the peripheral edge portion of the second laminate film 22.

The positive electrode tab 25 protrudes outward from the exterior body 20. The positive electrode tab 25 is electrically connected to the positive electrode 11 of the electrode body 10. The negative electrode tab 26 protrudes outward from the exterior body 20. The negative electrode tab 26 is electrically connected to the negative electrode 12 of the electrode body 10.

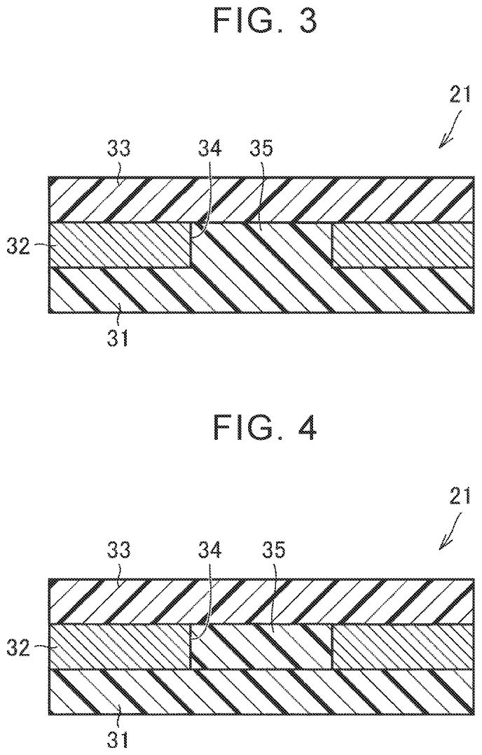

FIG. 3 is a cross-sectional view of the exterior body 20 showing an enlarged area III shown in FIG. 1. In FIG. 3, the first laminate film 21 is illustrated, and the structure of the laminate film is described. The second laminated film 22 also includes the same configuration as the first laminate film 21. The laminate film constituting the exterior body 20 includes a sealing layer 31, a barrier layer 32, and a protective layer 33.

The sealing layer 31 is formed of a resin material. The sealing layers 31 may be formed of, for example, non-oriented polypropylene (CPP), polyethylene (PE), or the like. The sealing layer 31 constitutes the inner surface of the exterior body 20. The sealing layer 31 has an inner surface facing the electrode body 10 and an outer surface facing the outside of the power storage device 1. The sealing layer 31 corresponds to an example of a resin layer.

The barrier layer 32 is formed of a metal material. The barrier layer 32 may be formed of aluminum, for example. The barrier layer 32 is disposed outside the sealing layer 31. The barrier layer 32 has an inner surface facing the electrode body 10 and an outer surface facing the outside of the power storage device 1. The outer surface of the sealing layer 31 and the inner surface of the barrier layer 32 face each other. The sealing layer 31 is laminated on the inner surface of the barrier layer 32. The barrier layer 32 corresponds to an example of a metal layer.

The protective layer 33 is formed of a resin material. The protective layer 33 is formed of a material different from the resin material constituting the sealing layer 31. The protective layers 33 may be formed of, for example, polyethylene terephthalate (PET). The protective layer 33 constitutes the outer surface of the exterior body 20. The protective layer 33 has an inner surface facing the electrode body 10 and an outer surface facing the outside of the power storage device 1. The outer surface of the barrier layer 32 and the inner surface of the protective layer 33 face each other. The protective layer 33 is laminated on the outer surface of the barrier layer 32.

An adhesive layer or an underlayer for enhancing bondability may be provided between the sealing layer 31 and the barrier layer 32. An adhesive layer or an underlayer may also be provided between the barrier layer 32 and the protective layer 33.

A plurality of through holes 34 is formed in the barrier layer 32. The through hole 34 penetrates the barrier layer 32 in the thickness direction. The through hole 34 may be formed by machining the barrier layer 32 or may be chemically formed. The through hole 34 may be formed in the barrier layer 32 before the sealing layer 31 and the protective layer 33 are laminated on the barrier layer 32.

The through hole 34 is, for example, a round hole. However, the shape of the through hole 34 is not limited. The through hole 34 may be formed in any other shape that is not circular. The plurality of through holes 34 may be arranged side by side in a grid pattern as shown in FIG. 2, for example. However, the plurality of through holes 34 may be arranged in a staggered manner, or may be arranged in any other arrangement. The plurality of through holes 34 may be arranged at equal intervals or may be arranged at different intervals.

The diameter of each through hole 34 is equal to or larger than 3 mm and equal to or smaller than 10 mm. The through hole 34 has a size visible to the naked eye. As shown in FIG. 2, when the through hole 34 has a circular shape, the through hole 34 has a diameter of not less than 3 mm and not more than 10 mm. When the through hole 34 has a non-circular shape, the largest passing dimension of the through hole 34 is equal to or larger than 3 mm and equal to or smaller than 10 mm.

The area ratio of the through hole 34 to the area of the barrier layer 32 is 3% or more and 40% or less. For example, the area ratio of the through hole 34 to the barrier layer 32 may be 3% or more and 40% or less in a range in which the electrode body 10 and the exterior body 20 overlap each other in a plan view of the power storage device 1 shown in FIG. 2.

A through hole 34 is formed in the barrier layer 32. On the other hand, no pores penetrating the sealing layer 31 are formed in the sealing layer 31. No holes are formed in the protective layer 33 to penetrate the protective layer 33. Since the sealing layer 31 and the protective layer 33 are formed of a resin material, they may have microscopic porosity. However, no macroscopically visible holes are formed in the sealing layer 31 and the protective layer 33.

A resin portion 35 made of a resin material is disposed in the through hole 34. A part of the sealing layer 31 stacked on the barrier layer 32 protrudes into the through hole 34. A portion of the sealing layer 31 protruding into the through hole 34 constitutes the resin portion 35. Therefore, the resin portion 35 is formed of the same material as the sealing layer 31.

The resin portion 35 shown in FIG. 3 is filled in the entirety of the through hole 34 and closes the entirety of the through hole 34. The resin portion 35 is in contact with the entire inner peripheral surface of the through hole 34. The front end surface of the resin portion 35 is in contact with the inner surface of the protective layer 33. The resin portion 35 does not necessarily have to be in contact with the protective layer 33. A gap may be formed between the resin portion 35 and the protective layer 33. The resin portion 35 may be filled in only a part of the through hole 34. The resin portion 35 may be present in a portion of the through hole 34. The other portion in the through hole 34 may be a hollow space.

The resin portion 35 may be formed of the same material as the protective layer 33. A portion of the protective layer 33 may constitute the resin portion 35.

FIG. 4 is a cross-sectional view illustrating another example of the exterior body 20. The resin portion 35 may be formed of a resin material different from the material forming either or both of the sealing layer 31 and the protective layer 33. For example, the resin material forming the resin portion 35 may have a lower moisture permeability than the resin material forming the sealing layer 31 and a lower moisture permeability than the resin material forming the protective layer 33. The resinous portion 35 may be formed of, for example, PVdF (polyvinylidene fluoride), FEP (ethylene tetrafluoride/propylene hexafluoride copolymer), or the like.

The resin material forming the sealing layer 31 or the protective layer 33 has necessary functions such as mechanical strength, chemical resistance, and workability. On the other hand, the resin material forming the sealing layer 31 or the protective layer 33 has relatively high moisture permeability. When a part of the sealing layer 31 shown in FIG. 3 constitutes the resin portion 35, the function of suppressing the intrusion of moisture into the inside of the power storage device 1 may be insufficient.

On the other hand, a resin material having low moisture permeability such as PVdF, FEP is difficult to be used as a material for forming the sealing layer 31 or the protective layer 33 in terms of mechanical strength, chemical resistance, processability, and cost. By using the resin material having low moisture permeability as the material to be filled in the through hole 34 formed in the barrier layer 32, the necessary functions of the sealing layer 31 and the protective layer 33 can be satisfied, and the intrusion of moisture into the inside of the power storage device 1 can be reliably suppressed.

In the power storage device 1 of the embodiment described above, as shown in FIGS. 3 and 4, the first laminate film 21 includes a sealing layer 31 which is a resin layer and a barrier layer 32 which is a metal layer. In the barrier layer 32, a through hole 34 penetrating the barrier layer 32 in the thickness direction is formed.

In the interior of the exterior body 20, gas may be generated by decomposition of an electrolytic solution or the like. The generated gas is dissolved in the sealing layer 31 of the exterior body 20. The gas cannot pass through the barrier layer 32 which is a metal layer. Gas that has moved in the sealing layer 31 and reaches the through hole 34 passes through the barrier layer 32 via the through hole 34 and is discharged to the outside. In the power storage device 1 of the embodiment in which the through hole 34 is formed in the barrier layer 32, the gas permeability of the exterior body 20 is improved as compared with the conventional power storage device including the laminate film in which the through hole is not formed in the metal layer.

A resin portion 35 is disposed in the through hole 34. The through hole 34 is sealed by the resin portion 35. Even when the through hole 34 penetrating the barrier layer 32 is formed, the through hole 34 is sealed by the resin portion 35, so that leakage of the electrolyte through the through hole 34 to the outside of the exterior body 20 is suppressed. Moisture is prevented from entering the inside of the exterior body 20 from the outside through the through hole 34.

By setting the diameter of the through hole 34 to be equal to or larger than 3 mm, the gases that have reached the through hole 34 can be easily discharged to the outside. Therefore, the gas permeability of the exterior body 20 can be improved. When the area ratio of the through hole 34 to the area of the barrier layer 32 is constant, if the diameter of the through hole 34 is too large, the distance that the gas moves in the sealing layer 31 until the gas reaches the through hole 34 increases. Then, the permeation rate of the gas decreases. When the diameter of the through hole 34 is set to be equal to or smaller than 10 mm value, it is possible to shorten the distance in which the gases move in the sealing layers 31. Then, the gas permeation rate can be ensured. Therefore, the gas permeability of the exterior body 20 can be improved.

As shown in FIG. 3, a portion of the sealing layer 31 protruding into the through hole 34 may constitute the resin portion 35. When the sealing layer 31 is laminated and integrated with the barrier layer 32 at the time of manufacturing the laminate film, a part of the sealing layer 31 enters the through hole 34. Then, the resin portion 35 is formed. Thus, the resin portion 35 can be easily formed. Then, the through hole 34 can be reliably sealed by the resin portion 35.

The protective layer 33 laminated on the outer surface of the barrier layer 32 is provided for the purpose of physical protection of the exterior body 20. The sealing layer 31 laminated on the inner surface of the barrier layer 32 serves to prevent leakage of the electrolyte to the outside. In some embodiments, a configuration in which a part of the sealing layer 31 forms the resin portion 35 is more desirable than a configuration in which a part of the protective layer 33 forms the resin portion 35 shown in FIG. 3.

As shown in FIG. 4, the resin portion 35 may include a different type of resin material than the material forming the sealing layer 31. As a result, it is possible to form the exterior body 20 by selecting an appropriate resin material that satisfies a necessary function as the material for forming the sealing layer 31 and the material for forming the resin portion 35.

As shown in FIG. 4, the resin portion 35 may include a resin material having a lower moisture permeability than the material forming the sealing layer 31. Accordingly, it is possible to reliably suppress moisture from passing through the through hole 34 and entering the inside from the outside of the power storage device 1. A resin material that is difficult to be used as a material for forming the sealing layer 31 or the protective layer 33 can be used as a material for forming the resin portion 35.

As shown in FIG. 2, when the area ratio of the through hole 34 to the area of the barrier layer 32 is 3% or more, the gas permeation rate can be ensured. Then, the effect of improving the gas permeability of the exterior body 20 can be reliably obtained. As the area ratio of the through holes 34 to the area of the barrier layer 32 increases, the mechanical strength of the laminate film decreases. In addition, when the area ratio exceeds a predetermined value, the increase ratio of the gas permeability decreases. By setting the area ratio of the through hole 34 to the area of the barrier layer 32 to 40% or less, the mechanical strength of the laminate film can be ensured so as to function as the exterior body 20, and the effect of improving the gas permeability can be appropriately obtained.

As shown in FIGS. 3 and 4, no macroscopically visible holes are formed in the sealing layer 31. When a hole is formed in the sealing layer 31, the electrolyte may leak to the outside through the hole. By suppressing a hole from being formed in the sealing layer 31, it is possible to reliably prevent the electrolyte from leaking to the outside of the exterior body 20.

Examples are described below. First, a laminate film used for evaluation was prepared. As a base material, a commercially available aluminum foil was used. Through holes were formed in the base material so as to have a predetermined diameter and area ratio. Resin films made of CPP were welded to both surfaces of the part of the base material where the through holes were formed to form a laminated film.

After the through holes are formed in the same manner as described above, a resin material having the same diameter as the through holes is disposed in the through holes, and thereafter, a resin film made of CPP is welded to both surfaces of the base material.

Next, a simulated gas simulating a gas component generated inside the exterior body 20 of the power storage device 1 was created. Hydrogen, carbon monoxide and methane were assumed as the main gas components. Then, the content was adjusted to be 4 vol %, carbon monoxide 48 vol %, and methane 48 vol %. The burning rate was taken into account, and the hydrogen-gas content was set to be less than or equal to 4 vol %.

Next, in order to measure the gas permeation amount of the laminate film, a simulated cell in which a simulated gas was enclosed was prepared. In the glove box filled with the simulated gas, the laminated film was formed into the shape of the exterior body of the power storage device, and thus the simulated cell was formed. An internal pressure sensor was inserted into the simulated cell to measure the internal pressure of the simulated cell.

For the simulated cell in which the simulated gas was enclosed, the amount of the gas component inside the simulated cell was measured by gas chromatography immediately after the encapsulation and 120 days after the storage. The gas permeation rate was calculated from the number of days elapsed, using the change in the amount of gas components immediately after encapsulation and 120 days after storage as the amount of permeated gas.

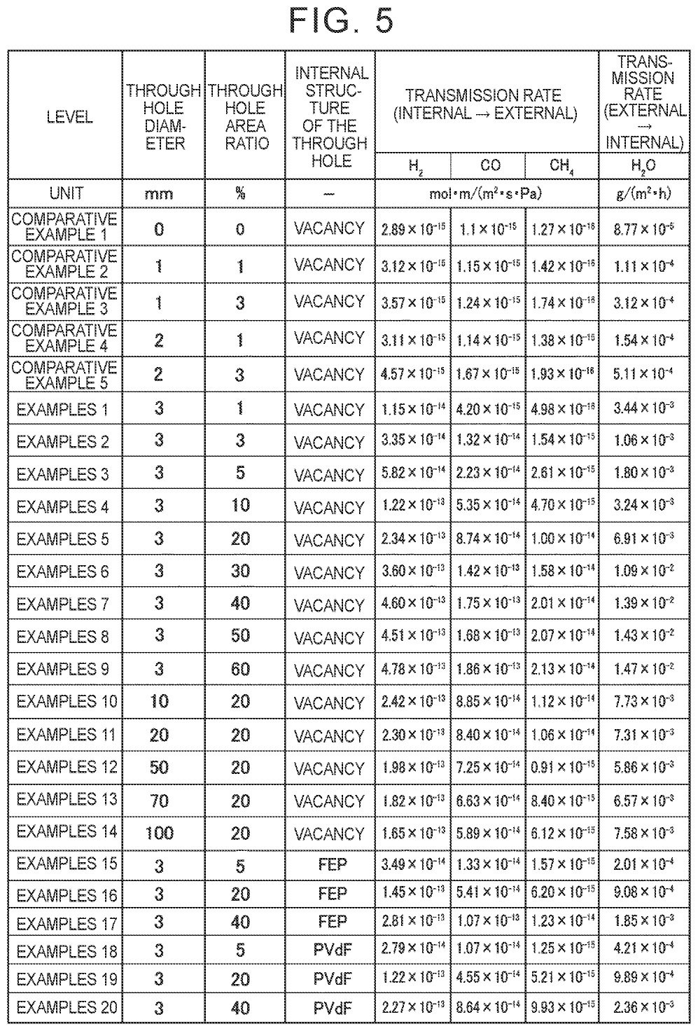

FIG. 5 is a table showing evaluation results of Examples and Comparative Examples. FIG. 5 shows the results of examining the relationship between the diameter of the through hole formed in the base material, the area ratio of the through hole to the area of the base material, and the configuration inside the through hole and the gas permeation rate.

A base material in which no through hole was formed was used as Comparative Example 1. In Comparative Example 2-5, the diameter of the through hole formed in the base material was set to be less than 3 mm. In Example 1-9, the diameter of the through hole formed in the base material was made constant in 3 mm, and the area ratio of the through hole was changed by changing the density of the through hole. In Example 10-14, the area ratio of the through hole was kept constant at 20%, and the diameter of the through hole was changed. In Example 15-20, the inside of the through hole was filled with a resin material (FEP, PVdF) other than CPP forming the resin film.

As shown in Examples 1-9, the gas permeation rate increased as the area ratio of the through holes increased. When the area ratio of the through holes was in the range of up to 40%, the gas permeation rate tended to increase proportionally. When the area ratio of the through hole exceeds 40%, the increase rate of the gas permeation rate is reduced, and the effect of increasing the area ratio is reduced. This is considered to be because, when the area ratio of the through holes increases to a certain level or more, the effect of lowering the partial pressure of the gas inside the simulated cell is caused. In addition, as the area ratio of the through holes increases, the mechanical strength of the laminate film decreases. In some embodiments, considering the role of the power storage device as an exterior body, the area ratio of the through hole is 40% or less.

In Example 1, when the area ratio of the through holes was 10%, the gas permeation rate was not sufficiently obtained. In some embodiments, in order to sufficiently increase the gas permeation rate, the area ratio of the through hole is set to 3% or more. In Comparative Example 2-5, when the diameter of the through hole was less than 3 mm, the permeation rate of the gases was not sufficiently obtained. In some embodiments, in order to sufficiently increase the gas-permeation rate, the diameter of the through hole may be equal to or larger than 3 mm.

As shown in Examples 5 and 10 to 14, when the diameter of the through hole is changed, there is almost no change in the gas-permeation rate when the diameter of the through hole is equal to or less than 10 mm. However, when the diameter exceeds 10 mm, the gas-permeation rate tends to gradually decrease. This is considered to be caused by the increase in the average distance to the through hole in the laminate film due to the increase in the diameter while the area ratio of the through hole is kept constant. The permeation of the gas in the laminate film is performed by a process of dissolving, diffusing, and externally releasing the gas into the resin on the inner peripheral side of the cell. Therefore, when the average distance to the through hole is increased, the distance required for diffusion is increased, and as a result, it is considered that the gas permeation rate is decreased. In some embodiments, the diameter of the through hole is 10 mm or less.

In Example 1-14, when the inside of the through hole was a hole, the amount of moisture entering from the outside tended to increase. As shown in Examples 15-20, it was shown that the penetration of moisture from the outside can be suppressed while the gas permeation rate inside is increased by filling the through hole with a resin material having low moisture permeability.

The presently disclosed embodiments and examples are to be considered in all respects as illustrative and not restrictive. The scope of the disclosure is indicated by the appended claims rather than by the foregoing description. It is intended that the scope of the disclosure include all modifications within the meaning and range of equivalency of the claims.

What is claimed is:

1. A power storage device comprising:
an electrode body; and
an exterior body that accommodates the electrode body and that is made of a laminate film, wherein:
the laminate film includes a metal layer and a resin layer laminated on a surface of the metal layer facing the electrode body;
a through hole penetrating the metal layer in a thickness direction is provided in the metal layer;
a diameter of the through hole is 3 mm or more and 10 mm or less; and
the laminate film further includes a resin portion disposed in the through hole.

2. The power storage device according to claim 1, wherein a part of the resin layer protruding into the through hole serves as the resin portion.

3. The power storage device according to claim 1, wherein the resin portion includes a resin material of a kind different from a material used for the resin layer.

4. The power storage device according to claim 3, wherein the resin portions includes a resin material having a lower moisture permeability than the material used for the resin layer.

5. The power storage device according to claim 1, wherein an area ratio of the through hole to an area of the metal layer is 3% or more and 40% or less.

6. The power storage device according to claim 1, wherein a hole that is macroscopically visible is not provided in the resin layer.
